(19) United States
(12) Patent Application Publication
(10) Pub. No.: US 2003/0175382 A1
(43) Pub. Date: Sep. 18, 2003

(54) Heat released encapsulated yeast

(76) Inventors: Vernetta L. Dally, White Plains, NY (US); David E. Martin, Branchville, NJ (US); Carl J. Pacifico, West Milford, NJ (US); Paul H. Richardson, McAfee, NJ (US)

Correspondence Address: Ronald J. Baron, HOFFMANN & BARON, LLP, 6900 Jericho Turnpike, Syosset, NY, 11791, US

(21) Appl. No.: 10/099,290

(22) Filed: Mar. 14, 2002

(51) Int. Cl. A21D 2/00

(52) U.S. Cl. 426/19

(57) ABSTRACT

The present invention is an encapsulated yeast composite comprising a core comprising yeast and a coating which comprises a low melting point lipid which melts at a temperature not greater than 95° F. The yeast includes Saccharomyces cerevisiae. The encapsulated composites are useful in the production of food compositions and food products.

### BACKGROUND OF THE INVENTION

The present invention relates generally to the art of food preparation, and, in particular, to the use of yeast in food.

Yeast is a living organism which is sensitive to its surrounding environment. For example, in the case of frozen or refrigerated dough, where yeast is used as the leavening agent, most commercial grades of yeast cannot withstand extended storage times under these conditions. As a consequence, yeast degrades.

The degradation of yeast has two significant impacts on its performance in a finished baked product. First, a significant portion of the yeast dies. Consequently, the level of activity of the remaining yeast is insufficient to produce carbon dioxide required to fully expand the cell structure of the dough. Thus, since the dough does not adequately rise, the resulting baked product is organoleptically inferior to the consumer.

Furthermore, the degradation of yeast results in the development of glutathione. Glutathione is a tripeptide consisting of glutamic acid, cysteine, and glycine. Glutathione is known to have a negative effect on the disulfide bonds in gluten, thereby disrupting the three dimensional structure of the gluten protein. As a result, the dough matrix becomes more relaxed, thus making the dough more extensible and resulting in a misshapened product, e.g., loaf.

Producers of yeast have done extensive work on culturing new strains of yeast which are more tolerant to frozen storage conditions. The yeast must also be available to the dough system before the dough reaches internal temperatures that will begin to set the starch and protein structure (i.e., three dimensional structure) of the dough.

Several patents disclose protecting yeast by encapsulating the yeast in a lipid or oil coating. U.S. Pat. No. 5,707,669 to Soltis, et al., describes encapsulating liquid cream yeast with hydrogenated vegetable oil. The coating of the encapsulated yeast softens at 125°-128° F., and becomes completely molten at a temperature no higher than 138° F.

Narayanaswamy, et al. describe in U.S. Pat. No. 6,261,613 B1 the formation of a dough or batter using an encapsulated yeast. The coating of the encapsulate includes a lipid which melts at a temperature between 95°-125° F.

It is beneficial to release the yeast at temperatures below the temperature where the yeast is known to become inactivated, especially in combination with moisture. Since proofing temperature of dough can occur at temperatures about 90° F., release of the yeast from the encapsulate at a lower temperature after frozen storage or refrigeration will enable the yeast to generate more carbon dioxide at lower temperatures, resulting in improved leavening.

The improved leavening capabilities of the yeast will effectively reduce the proofing time compared to that of the higher melting point encapsulated yeast described in the above patents. In addition, the leavening will occur at a temperature before the starch and protein structures of the dough begin to set.

Therefore, there is a need for an encapsulated yeast suitable for frozen and refrigerated storage, which would allow for release of the yeast at a lower temperature which is below the temperature at which the dough begins to set and below the critical temperature which would kill the yeast. Further, release of the yeast at lower temperatures effectively maintains the standard proofing times (e.g., proofing time of dry active unencapsulated yeast).

### SUMMARY OF THE INVENTION

The present invention includes an encapsulated yeast composite and compositions thereof, especially food compositions and products therefrom. The present invention also includes a method for preparing food compositions and products using the unique composite.

The encapsulated yeast composite includes a core which contains yeast and a coating which contains a low melting point lipid.

The low melting point lipid includes a lipid which melts at a temperature not greater than 95° F. Preferably, the coating melts at a temperature not greater than 90° F. Lipids which melt at the preferred temperature range include certain vegetable oils having the desired melt characteristics. Preferably, the vegetable oil used herein is hydrogenated palm kernel oil.

The yeast useful in the present invention is any dry yeast, including Saccharomyces cerevisiae. In a preferred embodiment, the yeast is INSTANT yeast. The minimum amount of yeast present in the composite is about 5% by weight of the composite, preferably about 30%, and more preferably about 50% by weight of the composite. The maximum amount of yeast present in the composite is about 95% by weight of the composite, preferably about 92%, and more preferably about 90% by weight of the composite. In the most preferred embodiment, the yeast is present in the composite in an amount about 85% by weight of the composite.

The food composition containing the composite includes dough or a dry mix package. In a preferred embodiment, the dough can be a stored dough, which is one embodiment of the invention. The dough can be stored at refrigeration or frozen temperatures.

The food product includes the composite which is combined with other food ingredients. The combination is subjected to a temperature which releases the yeast. In a preferred embodiment, the combination is dough. The dough is proofed and baked to obtain the food product. Preferably, the food product is a bakery product, and more preferably, a bread product.

As a result of the present invention, yeast is provided which can tolerate storage conditions (e.g., frozen or refrigeration temperatures and moisture) encountered by food compositions, such as a dough. Furthermore, the earlier release of the yeast occurs before a temperature which begins to set the starch and protein structure of a food composition, thereby allowing the food composition to rise properly due to increased carbon dioxide production, thus resulting in a food product which is organoleptically pleasing to the consumer.

For a better understanding of the present invention, together with other and further advantages, reference is made to the following detailed description, and its scope will be pointed out in the claims.

### DETAILED DESCRIPTION OF THE INVENTION

An encapsulated yeast according to the present invention is a composite which includes a core containing yeast and a coating which encapsulates the core. The minimum amount of yeast present in the composite is about 5% by weight of the composite, preferably about 30%, and more preferably about 50% by weight of the composite. The maximum amount of yeast present in the composite is about 95% by weight of the composite, preferably about 92%, and more preferably about 90% by weight of the composite. In the most preferred embodiment, the yeast is present in the composite in an amount about 85% by weight of the composite.

The coating for the encapsulated yeast is prepared from materials which do not crack upon freezing. A coating that does not crack upon freezing protects the yeast from loss of activity due to moisture. The coating completely surrounds the yeast such that the yeast is protected from the surrounding environment until it is released at the appropriate time. The appropriate time useful in the present invention can be determined by controlling the temperature.

The coating provides a hydrophobic barrier. An example of a hydrophobic barrier is a lipid. Preferably, the lipid is a low melting point lipid.

A low melting point lipid is any lipid which has a melting point temperature not greater than 95° F. Preferably, the melting point temperature is not greater than 90° F. The lipid preferably includes hydrogenated vegetable oil, including triglycerides, such as hydrogenated palm kernel oil, other vegetable and animal derived waxes and mixtures thereof. Monoglycerides and diglycerides can also be included. The lipid can be saturated or partially saturated. Preferably, the low melting point lipid is hydrogenated palm kernel oil.

The coating can also contain additives. Typically, the additives can be used to enhance release of the yeast. Preferably, the additives generate gases which disrupts the coating. The gases generated by the additives can also contribute to the leavening process.

The additives can include any material which helps to facilitate disruption of the coating. Preferably, the additives aid in disruption of the coating after storage of the food composition (e.g., dough). The additives can be activated by, for example, moisture, temperature, pH, or any combination thereof. The additives can include, for example, ammonium bicarbonate and sodium bicarbonate. Preferably, the additive is ammonium bicarbonate.

Yeast useful in the present invention is any dry yeast which generates carbon dioxide which is beneficial for proofing of dough. For example, the yeast can be Saccharomyces cerevisiae. In a preferred embodiment, the yeast is INSTANT yeast.

INSTANT yeast as used herein is a highly active yeast which does not need to be prefermented (i.e., reconstituted with water and sugar) before use. INSTANT yeast activates rapidly in warm water. Some examples of INSTANT yeast include Rapid Rise Yeast and Bread Machine Yeast.

The composites of the present invention can be stored at room, refrigeration or frozen temperatures for up to a year or more. Typically, room temperature is from about 60° F. to about 80° F. Refrigeration temperature is usually from about 34° F. to about 46° F. and frozen temperatures are typically less than about 20° F.

Food compositions contemplated as part of the present invention are those food compositions which beneficially include an encapsulated yeast composite having a low melting point lipid coating. The compositions can, for example, include flour, eggs, sugar and salt. The amount of each ingredient useful for the composition of the present invention is known to those skilled in the art. The composition can, for example, be a dough or a dry mix package.

The dough can be a stored dough. The stored dough can be stored at refrigeration or frozen temperatures. The refrigerated dough can be stored for usually about one week at refrigeration temperature. The frozen dough can be stored for usually about 6 months or more at frozen temperature.

The dry mix package which is purchased by the consumer can be reconstituted with a solvent to form a dough. For example, an aqueous solvent such as water and milk can be used. The dry mix package can be stored at room, refrigeration, or frozen temperatures. Preferably, the dry mix is stored at room temperature. The dry mix packages can be stored for an extended period of time. Typically, the storage period can be up to one year or more.

A food product can be prepared by combining an encapsulated yeast composite of the present invention with other ingredients. These components can be combined by any method known in the art. The method can, for example, include mechanical means, such as a mixer, or manual means, such as by hand.

The other food ingredients can, for example, include flour, eggs, salt, sugar, and water. The amounts and proportions of encapsulated yeast composites and the other food ingredients are known to those skilled in the art. The combination formed can be a dough.

When the encapsulated yeast composite is included in a dough or a dough made from a dry mix package, proofing is usually one of the steps for preparing a food product. Proofing is a process where yeast converts sugar into carbon dioxide, thereby allowing the dough to rise. Proofing is initiated by subjecting the combination described above (e.g., dough) to a temperature which releases the yeast. The temperature which enables the release of the yeast is typically at or above the melting point of the lipid coating of the encapsulated composite.

The yeast needs to be fully available to the dough system in order for the dough to be effectively proofed. Since it takes time for the lipid coating to melt and to fully disperse, it is beneficial to use a low melting point encapsulated yeast composite for a sooner release of the yeast, as compared to a composite with a relatively high melting point (e.g., 95°-125° F.), which would provide a later release of the yeast.

Once the yeast are released, the dough is typically proofed at a temperature greater than about 90° F. (e.g., 100° F.). After proofing, the dough is baked at a temperature and time known to those skilled in the art, to provide a food product (e.g., bread).

The food product can be any food product which beneficially include an encapsulated yeast composite. Some examples of a food product include, for example, a pizza crust or a bakery product. The bakery product can be, for example, a roll, bun, biscuit, or bread. Preferably, the bakery product is a bread product.

### EXAMPLES

### Example 1

Encapsulation of Yeast with Low Melting Point Lipid.

Yeast, such as INSTANT yeast, is coated by spraying the molten lipid coating onto the yeast using an encapsulation process. An example of an encapsulation process is a fluidized bed spray applicator as shown in U.S. Pat. No. 3,913,847 and is hereby incorporated by reference in its entirety. The method of coating is not limited, however, to the process shown in U.S. Pat. No. 3,913,847. One of ordinary skill in the art will appreciate that the present invention may also be practiced utilizing other encapsulation processes, such as spray chilling and spinning disk.

The encapsulated composites results in extended storage of the yeast.

### Example 2:

Improved Leavening of Dough Containing Encapsulated Yeast Composites.

Doughs were prepared with the following formulations:

| Ingredient | Formulation 1 (g) | Formulation 2 (g) |
|---|---|---|
| Bread flour | 456 | 456 |
| Sugar | 19.74 | 19.74 |
| Salt | 10.29 | 10.29 |
| Non fat dried milk | 7.43 | 7.43 |
| Fleischman's Yeast | 5.08 | — |
| Shortening flakes | 18 | 18 |
| Water | 251.39 | 251.39 |
| 85% active yeast encapsulate | — | 5.98 |

After preparing the doughs according to formulation 1 and 2, the doughs were frozen at 0° F. for 3 days and then refrigerated at 38° F. for 24 hours.

After storage, the doughs were proofed at 100° F. for 1 hour then baked at 375° F. for 15 minutes. Formulation 1 gave some rise, whereas formulation 2 provided an excellent higher rise. The rise observed for formulation 1 was almost at the top level of the baking pan. In contrast, the rise observed for formulation 2 was substantially above the top level of the baking pan. The observation of bread rise demonstrated improved refrigeration and frozen storage stability for the encapsulated yeast (formulation 2).

As a result of the present invention, composites can be prepared (in compositions and products therefrom) which protects the yeast during storage, such as those encountered during refrigeration or frozen storage, to provide excellent leavening capabilities. Furthermore, extended storage times would greatly benefit from the use of encapsulated yeast composites versus unencapsulated yeast.

Thus, while there have been described what are presently believed to be the preferred embodiments of the invention, changes and modifications can be made to the invention and other and further embodiments will be known to those skilled in the art, which fall within the spirit of the invention, and it is intended to include all such other changes and modifications and embodiments as come within the scope of the claims as set forth hereinbelow.

What is claimed is:

1. An encapsulated yeast composite comprising:
(a) a core which comprises yeast; and
(b) a coating comprising a low melting point lipid which melts at a temperature not greater than 95° F.

2. A composite according to claim 1, wherein said coating melts at a temperature not greater than 90° F.

3. A composite according to claim 1, wherein said coating comprises vegetable oil.

4. A composite according to claim 3, wherein said vegetable oil is hydrogenated palm kernel oil.

5. A composite according to claim 1, wherein said coating comprises additives.

6. A composite according to claim 5, wherein the additive is ammonium bicarbonate.

7. A composite according to claim 1, wherein said yeast is Saccharomyces cerevisiae.

8. A composite according to claim 7, wherein said yeast is INSTANT dry yeast.

9. A composite according to claim 1, wherein said yeast is present in an amount from about 5% to about 95% by weight of the composite.

10. A composite according to claim 9, wherein said yeast is present in an amount not less than about 30% by weight of the composite.

11. A composite according to claim 10, wherein said yeast is present in an amount not less than about 50% by weight of the composite.

12. A composite according to claim 9, wherein said yeast is present in an amount not greater than about 92% by weight of the composite.

13. A composite according to claim 12, wherein said yeast is present in an amount not greater than about 90% by weight of the composite.

14. A composite according to claim 9, wherein said yeast is present in an amount about 85% by weight of the composite.

15. A food composition comprising an encapsulated yeast composite which comprises:
(a) a core comprising yeast; and
(b) a coating comprising a low melting point lipid which melts at a temperature not greater than 95° F.

16. A composition according to claim 15, wherein said coating comprises vegetable oil.

17. A composition according to claim 16, wherein said vegetable oil is hydrogenated palm kernel oil.

18. A composition according to claim 15, wherein said yeast is Saccharomyces cerevisiae.

19. A composition according to claim 18, wherein said yeast is INSTANT yeast.

20. A composition according to claim 15, wherein said composition is dough.

21. A composition according to claim 20, wherein said dough is stored dough.

22. A composition according to claim 21, wherein said dough is stored at refrigeration temperature.

23. A composition according to claim 21, wherein said dough is stored at frozen temperature.

24. A composition according to claim 15, wherein said composition is a dry mix package.

25. A method for preparing a food product comprising:
(a) combining an encapsulated yeast composite, which comprises a core comprising a yeast and a coating which comprises a low melting point lipid which melts at a temperature not greater than 95° F., with other food ingredients;
(b) subjecting said combination resulting from step (a) to a temperature which releases said yeast.

26. A method according to claim 25 wherein said coating melts at a temperature not greater than 90° F.

27. A method according to claim 25, wherein said coating comprises vegetable oil

28. A method according to claim 25, wherein said yeast is Saccharomyces cerevisiae.

29. A method according to claim 28, wherein said yeast is INSTANT yeast.

30. A method according to claim 25, wherein said combination is dough.

31. A method according to claim 30, further comprising:
(a) proofing said dough at a temperature greater than about 90° F.; and
(b) baking said dough.

32. A method according to claim 30, wherein said dough is stored.

33. A method according to claim 32, wherein said dough is stored at refrigeration temperature.

34. A method according to claim 32, wherein said dough is stored at frozen temperature.

35. A method according to claim 25, wherein said food product is a bakery product.

36. A method according to claim 35, wherein said bakery product is a bread product.

37. A food product prepared according to a method comprising:
(a) combining an encapsulated yeast composite, which comprises a core comprising a yeast and a coating which comprises a low melting point lipid which melts at a temperature not greater than 95° F., with other food ingredients;
(b) subjecting said combination resulting from step (a) to a temperature which releases said yeast.

38. A food product according to claim 37, wherein said coating melts at a temperature not greater than 90° F.

39. A food product according to claim 37, wherein said coating comprises vegetable oil.

40. A food product according to claim 37, wherein the yeast is Saccharomyces cerevisiae.

41. A food product according to claim 40, wherein the yeast is INSTANT yeast.

42. A food product according to claim 37, wherein the combination is dough.

43. A food product according to claim 42, wherein said dough is proofed at a temperature greater than about 90° F. and baked.

44. A food product according to claim 42, wherein the dough is stored at refrigeration temperature.

45. A food product according to claim 42, wherein the dough is stored at frozen temperature.

46. A food product according to claim 37, wherein the combination is a dry mix package.

47. A food product according to claim 46, wherein the dry mix package is stored.

48. A food product according to claim 37, wherein the food product is pizza crust.

49. A food product according to claim 37, wherein the food product is a bakery product.

50. A food product according to claim 49, wherein the bakery product is a bread product.
